(19) United States
(12) Patent Application Publication
(10) Pub. No.: US 2010/0057519 A1
(43) Pub. Date: Mar. 4, 2010

(54) SYSTEM AND METHOD FOR ASSIGNING SERVICE REQUESTS WITH DUE DATE DEPENDENT PENALTIES

(76) Inventors: Chitra Dorai, Chappaqua, NY (US); Anshul Sheopuri, Hartsdale, NY (US); Sai Zeng, Yorktown Heights, NY (US)

Correspondence Address: TUTUNJIAN & BITETTO, P.C., 20 CROSSWAYS PARK NORTH, SUITE 210, WOODBURY, NY, 11797, US

(21) Appl. No.: 12/199,125

(22) Filed: Aug. 27, 2008

(51) Int. Cl. G06F 15/02

(52) U.S. Cl. 705/9

(57) ABSTRACT

A system and method for deciding assignments for service requests includes determining a best policy, within a class of index-based policies, based upon historic data for handling previous requests. If a service request is waiting to be handled, an index for service requests is determined based upon the best policy and service requests are assigned to agents based upon the index. Service requests are preempted if a waiting service has a higher index than other service requests.

### BACKGROUND

1. Technical Field

The present invention relates to assignment systems and methods and, more particularly to systems and methods that determine the handling of assignments involving service requests by customers.

2. Description of the Related Art

Several large companies employ complex service systems (SS) to support hardware and software issues faced by users. Such services are typically outsourced to information technology (IT) service providers. The performance of the system is governed by a mutually agreed upon contract between the buyer and the service provider. The form of the penalties espoused by the contract depends on the context.

A contract is typically characterized by Service Level Agreement (SLA) penalties of the following form: “If a service request of severity level k is not resolved in time x, the service provider incurs a cost $y”. Modeling the performance of service systems has mainly focused on addressing two questions: (1) staffing, i.e., how many agents should be staffed on a particular shift, and, (2) assignment, i.e., what policy should be followed to assign requests to agents?

A well-cited rule for staffing is the “Square root safety rule”, which suggests keeping a square root of workload safety stock of agents, analogous to classical inventory models. Several researchers have tried to address the question of staffing and assignment jointly. However, oftentimes, staffing decisions are tactical and cannot be implemented simultaneously with routing decisions.

Among the policies suggested for assignment, the First-Come-First-Serve (FCFS) is most common. This intuitive policy suggests that requests be assigned in the order in which they are received. In systems with service requests of multiple severity levels, FCFS (with priority) is a natural extension to the FCFS policy. In this policy, requests are assigned in the order that they are received, but with strict preference given to higher severity requests. FCFS and priority FCFS will be used interchangeably to mean severity level preference based assignment. While the FCFS policy is intuitive, it does not consider the penalty costs, due dates, etc. which are seen in practice. Recently, researchers have developed policies with the objective of minimizing the costs stipulated in the contract. “Dynamic scheduling with Convex delay Costs: The Generalized cμ rule”, Van Meighem, The Annals of Applied Probability. 5(3) 808-833, 1994 shows the asymptotic optimality of the Generalized cμ rule for convex delay costs and a single agent. According to this policy, service requests are assigned dynamically based on the product of the service rate and marginal cost at the age (or time in system) of service request. “Due date Scheduling: Asymptotic Optimality of Generalized Longest Queue and Generalized Largest Delay Rules”, Van Meighem, Operations Research 51(1) 113-122, 2003 (hereinafter Van Meighem), studies costs which are a function of whether the job has resided in the system longer than its due date. The generalized cμ rule analysis is employed to show that the Generalized Longest Queue (GLQ) policy is asymptotically optimal in the case when there is a single agent only.

For the problem of scheduling jobs to minimize the weighted flow time, “Various Optimizers for Single Stage Production”, Smith, Naval Research Logistics Quarterly 3 59-66, 1956 shows the optimality of the Weighted Shortest Processing Time (WSPT) policy. According to this policy, each service request is assigned a number, given by the product of the weight assigned to the request and the inverse of the processing time. The requests are then scheduled for service in ascending order of the numbers assigned to them.

### SUMMARY

The present principles are applicable to processes which may or may not permit preemption. In fact, the GLQ policy proposed by Van Meighem is also asymptotically optimal for the case when preemption is permitted. Further, the FCFS and WSPT policies discussed above extend to the case of preemption, based on the priority level or number assigned to the request respectively.

In the case of preemption, the present principles permit for work-saving, e.g., if a service request is preempted, another agent who is assigned this task learns about the prior resolution attempts. This assumption is not unreasonable as agents document solutions that have been attempted. However, note that the present principles carry over to the no work-saving case as well.

In a first aspect, exemplary embodiments provide a method to make a decision as to when to assign a particular service request submitted by a customer to an assignment system and to which agent. The method includes computing the cost of operating each policy within a proposed class of policies. The optimal policy is determined within the class, and a recommendation is generated of when to assign a service request and when to preempt a service request.

The exemplary embodiments further provide determining the optimal policy, within a class of index-based policies; computing the index of each severity for the optimal parameters; determining which service request should be routed to an agent, if necessary; and determining which service request should be preempted by an agent, if necessary.

In a further aspect, a data processor includes an input for receiving a service request submitted by a customer to a dispatching system. A service request processing unit is coupled to the input and adapted to determine whether and when to assign a request. An output is coupled to the service request processing unit for outputting a recommendation of when and to whom to assign a service request, where the claim processing unit is adapted to apply the optimal policy, within a class of index-based policies. The class of index-based policies includes well known heuristic policies such as the FCFS, SPT, WSPT and the GLQ policies, to compute the index of each severity level for every small time increment: if at least one service request is waiting to be assigned, to assign the highest index service request to an agent; if at least one is free, to preempt the lowest index service request among those being processed by agents by the highest waiting service request, if all agents are processing requests and the severity level of the highest index waiting service request is greater than the severity level of the lowest index severity level being processed.

In another aspect of the exemplary embodiments, an assignment decision is made for a service request submitted by a customer. The operations include simulating the optimal cost of a service system for each x and y, where x and y represent decision criteria. The optimal x and y are pre-determined based on the policy that results in the lowest SLA penalty cost. The index of all service requests severity levels is computed, if at least one service request is waiting. The highest index service request is assigned to an agent, if one is free. The lowest index service request is preempted by being processed by the highest index waiting service request, if all agents are busy.

A system and method for deciding assignments for service requests includes determining a best policy, within a class of index-based policies, based upon historic data for handling previous requests. If a service request is waiting to be handled, an index for service requests is determined based upon the best policy and service requests are assigned to agents based upon the index. Service requests are preempted if a waiting service has a higher index than other service requests.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing static (batch) and dynamic (operations) components for a system for assigning service requests in accordance with one exemplary embodiment;

FIG. 2 is a graph showing a percentage improvement (decrease in total service level agreement penalty costs) of the present policy over a FCFS policy for different service level agreement penalty costs of severity 1 service requests as a function of number of agents;

FIG. 3 is a graph showing the percentage improvement (decrease in total service level agreement penalty costs) of the present policy over a FCFS policy for different mean service rates of severity 2 service requests as a function of number of agents;

FIG. 4 is a block/flow diagram showing a system/method or assigning service requests in accordance with an exemplary embodiment; and

FIG. 5 is a block/flow diagram of a computing system that is a suitable environment for implementing the present principles.

### DETAILED DESCRIPTION OF PREFERRED EMBODIMENTS

The present principles make a decision as to when and to which agent to assign a service request submitted by a customer. The present principles include developing a class of index-based policies for assigning service requests to agents with the objective of minimizing due-date dependent service level agreement (SLA) penalty costs. The class of policies provided herein may be considered a generalization of First-Come-First-Serve (FCFS), Shortest Processing Time (SPT), Weighted Shortest Processing Time (WSPT), and Generalized Longest Queue (GLQ) policies.

The exemplary embodiments in accordance with the present principles solve the problem of assigning service requests to agents. As an example, service requests include tickets generated by customers including information such as an opening time of ticket, due date of the ticket, severity level of the ticket and cost of Service Level Agreement (SLA) violation. Agents are service representatives who resolve tickets and may be human or implemented in the form of a machine or automated handling device. In the context of the ensuing description of the exemplary embodiments “dispatching” or “assignment” refers to a process of making a decision of when and to which agent to assign a service request for processing.

In a special case of threshold-based SLA penalties the exemplary embodiments are particularly useful. As employed herein a “threshold-based penalty” is intended to be a class of penalty functions where no penalty is incurred if the service request is resolved by a pre-specified due date, and a fixed penalty is incurred if the processing time of the service request exceeds the due-date.

The exemplary embodiments provide a method and system for assigning service requests, and are especially useful with, but are not limited for use with, threshold based SLA penalty costs. The method and system support a class of index based policies that may include a generalization of the FCFS, SPT, WSPT and GLQ policy. The use of the exemplary embodiments permits for a manager of a service system to decide when and to which agent a particular service request is to be assigned based on a class of index based policies. A systematic approach is provided to deal with the problem of assigning service requests, especially in the context of threshold based SLA penalties.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

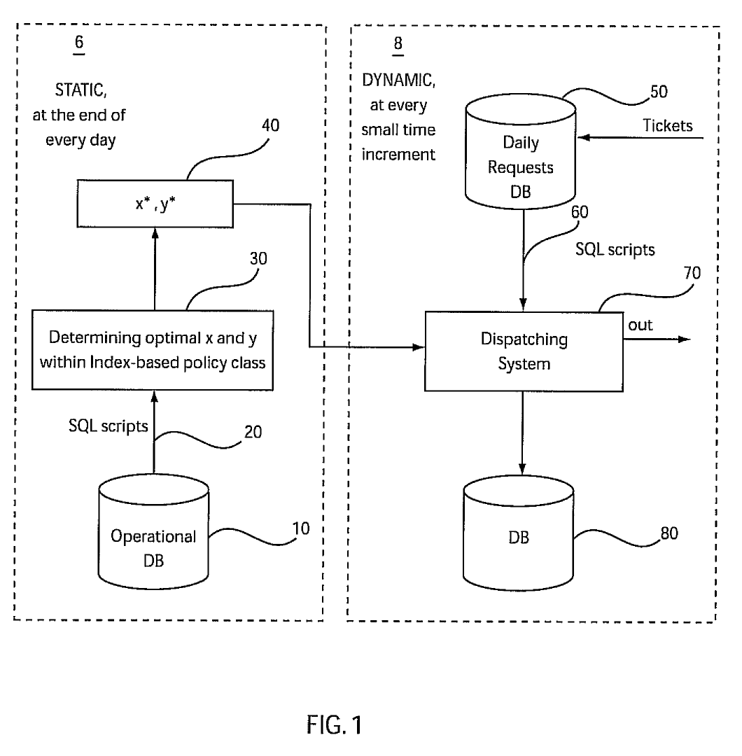

Referring now to the drawings in which like numerals represent the same or similar elements and initially to FIG. 1, an exemplary embodiment for creating a historic database with indexes for assigning service requests to agents is illustratively shown. Operations depicted in block 6 are preferably batch processes, for example, performed at the end of the day or other period of time. An operational database (DB) 10 includes historical information pertaining to service requests. A random subset of the historical service requests are extracted through structure query language (SQL) scripts 20 into an optimization unit 30 to determine an optimal x and y, which represent metrics of interest and which together provide an index used in determining agent assignments. Unit 30 may perform exhaustive searches or compile statistics to determine a policy with the best characteristics in accordance with a current application. The optimal x and y are denoted by x* and y* within a class of index-based policies.

Operations in block 8 are dynamic, for example, performed at every small time increment. Service requests are inputted into a daily requests database 50. The requests are inputted into a dispatching system 70 through SQL scripts 60, which are then outputted to a DB 80.

In one embodiment, a class of index-based policies is provided that is a generalization of the GLQ, SPT, WSPT and PCFS polices and may be implemented by means of a heuristic, which is particularly useful for threshold-based SLA penalties. The exemplary embodiments assume the presence of a dataset related to service requests over a period of time that includes detailed information about the service request, e.g., opening time, severity level, due date, service time and SLA penalty cost.

The preferred embodiments employ a model that enables a manager of a dispatching system 70 to decide when to assign a particular service request and to which agent.

To overcome the deficiency of lack of knowledge of the optimal cost of dispatching, we benchmark the performance of the optimal policy, within the class of index-based policies against the FCFS policy and show theoretically, that the policy class includes well-known heuristic policies like the FCFS, SPT, WSPT and GLQ.

With regard to the heuristic, a discussion is now made of the notation that is employed. We first review some notation introduced in Van Meighem, incorporated herein by reference in its entirety. Let the service requests comprise n levels of severity, denoted by 1, 2, . . . , n. We will use k to denote the severity level of a generic service request.

Let λₖ and μₖ be the average arrival rate and service rate of severity k tickets respectively. Let cₖ be the penalty cost incurred if a service request is not resolved within its due date Dₖ. The contract between the buyer and service provider stipulate higher SLA cost penalties for the more important severity levels. Requests with higher penalty costs are also more difficult to solve and their mean service rates are thus lower. Consequently, without loss of generality, we assume that the penalty costs and service rates are ordered in severity levels as follows:

c₁>c₂> . . . >c₁ and μ₁<μ₂< . . . μ₁.

As stated earlier, Van Meighem considers an SS with requests of multiple severity levels, due dates, SLA penalty costs and a single agent. Since considering the objective as a weighted sum of the indicator functions, I{Dₖ>τₖ} is intractable, Meighem considers a sequence of continuous penalty costs, which is discontinuous in the limit. Using results from Van Meighem in “Dynamic scheduling with Convex delay Costs: The Generalized cμ rule”, The Annals of Applied Probability. 5(3) 808-833, (1994) (hereinafter Meighem '94), incorporated herein by reference, Meighem shows that a dynamic priority rule, which he refers to as the Generalized Longest Queue (GLQ) policy, is asymptotically optimal. The GLQ policy is FCFS within a class and prioritizes the severity level with highest index (I) at time t, defined as:

$${I}_{k} ( t ) = \frac{{N}_{k} ( t )}{{λ}_{k} {D}_{k}} ,$$

where Nₖ(t) is the number of severity k requests in the system at time t, and Dₖ is the due date of severity k service requests.

While the GLQ policy proposed by Van Meighem is asymptotically optimal for the case of a single agent, the present setting is of multiple agents. We propose a new policy class with two parameters, x and y, which we called the index-based class of policies. For a given x and y, the policy is a modification of the GLQ policy with a SLA penalty cost and service rate term considered multiplicatively: Inₖ(t)=(cₖ)^{x}(μₖ)^{y}Iₖ(t), where cₖ is the penalty cost incurred if a service request is not resolved within its due date (Dₖ).

Exemplary embodiments employ a similar approach to assigning service requests to agents by extending the GLQ policy to a new class of policies, which we refer to as index-based policies. The index-based policy is sensitive to SLA penalty costs and service rates, which shows that this class encompasses the FCFS policy, the SPT policy, the WSPT policy and the GLQ policy.

Suppose the number of request arrivals in a time interval [0, T] is bounded above by m(T)<∞. Then, for the class of index-based routing policies n(x,y) operated during [0,T], the following statements hold:

1) For a given y, there exists m₁(T)<∞ such that for x>m₁(T), n(x,y) is FCFS.

2) For a given x, there exists m₂(T)<∞ such that for y>m₂(T), n(x,y) is SPT.

3) There exists m₃(T)<∞ such that for x=y>m₃(T), n(x,y) is WSPT.

4) For x=y=0, n(x,y) is GLQ.

To simulate a Service Request Assignment System (SS), we used data from a large service provider. The data set includes information regarding 297 service requests currently dispatched according to a FCFS policy. The dataset includes information about arrival times, service times, severity levels and due dates. Since we do not know the optimal policy or the optimal cost, we benchmark the performance of the policy against the FCFS policy.

We tested the performance of the present policy for 21 problem instances of SLA penalty costs and mean service times. We benchmarked the performance of our policy by comparing the cost that can be “affected” with that of the FCFS policy. Define the “sunk cost” as the cost of service request violations corresponding to requests whose service time exceeds the due date. This cost corresponds to SLA penalty violations which are unavoidable, i.e., the cost incurred irrespective of the number of the agents that are staffed.

Since any policy that we propose cannot affect the sunk cost associated with SLA penalty violations, we compute the difference of the cost of SLA penalty violations and the sunk cost as the metric of performance of a policy. We define this to be the “operating cost” of the policy. To benchmark the performance of the index policy, we compute the percentage improvement of the operating cost of the index policy over the operating cost of the FCFS policy. We first summarize the results of our computational study and then examine sensitivity results with the problem parameters. In one illustrative example, the average percentage improvement in operating cost of the optimal policy, within the class of index-based policies, compared to the FCFS policy was 10.86% over the set of 21 problem instances that we tested.

The performance of our policy compared to the FCFS policy when the number of agents, the penalty costs and the service rates are varied will now be described. We first note that the performance of both policies is similar when the number of agents is either small or large. The intuition behind this observation is as follows. When the number of agents is small, both policies primarily target reductions in severity “1” service requests. When the number of agents is large, some agents are “always free” and thus the policy does not need to be intelligent. This observation can be noted in Table 1, which provides the number of service request violations by severity level for the FCFS policy and the index-based policy in case of preemption for a particular problem instance. The last two columns in the table provide the costs associated with the SLA violations.

TABLE 1
Performance of index-based policies against the
FCFS policy for a specific problem instance.

| | # Request | | | | # Request | | | | | |
|---|---|---|---|---|---|---|---|---|---|---|
| | Violations | | | | Violations | | | | | |
| | (FCFS) | | | | (Index) | | | | | |
| | Sev1-Sev2- | | | | Sev1-Sev2- | | | | | |
| | Sev3-Sev4 | | | | Sev3-Sev4 | | | | | |
| #Agents | violations | | | | violations | | | | C (FCFS) | C (Index) |
| 3 | 29 | 99 | 54 | 1 | 29 | 99 | 54 | 1 | 3306 | 3306 |
| 6 | 25 | 93 | 47 | 0 | 25 | 93 | 1 | 0 | 2873 | 2781 |
| 9 | 20 | 76 | 44 | 0 | 20 | 76 | 15 | 0 | 2316 | 2306 |
| 12 | 15 | 26 | 1 | 0 | 15 | 26 | 1 | 0 | 1580 | 1580 |

Next, we consider the performance of the Index-based policy against the FCFS policy when the penalty costs and service rates are varied. We expect that greater benefit can be derived from using the index-based policy against the FCFS policy if the penalty costs are “similar” or the service rates are “dissimilar”, because in either case, there is a greater incentive to give preference to a lower severity level.

Let xⁱ, i=1,2,3 be n-dimensional vectors and let

xⁱ=(x₁ⁱ,x₂ⁱ, . . . ,xₙⁱ).

Definition: Let 2≦k≦n. Let xⱼ¹=xⱼ²∀jε{1,2,3, . . . , n}\k. We say that the components of x² are less similar than those of x¹ (the components of x¹ are more similar than those of x²) if

|xₖ¹−xₖ₊₁¹|≦|xₖ²−xₖ₊₁²|.

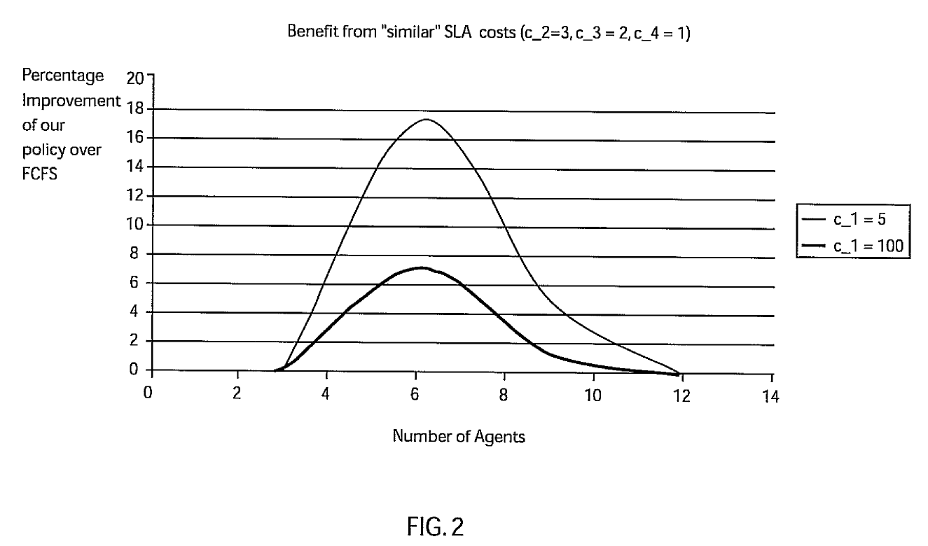

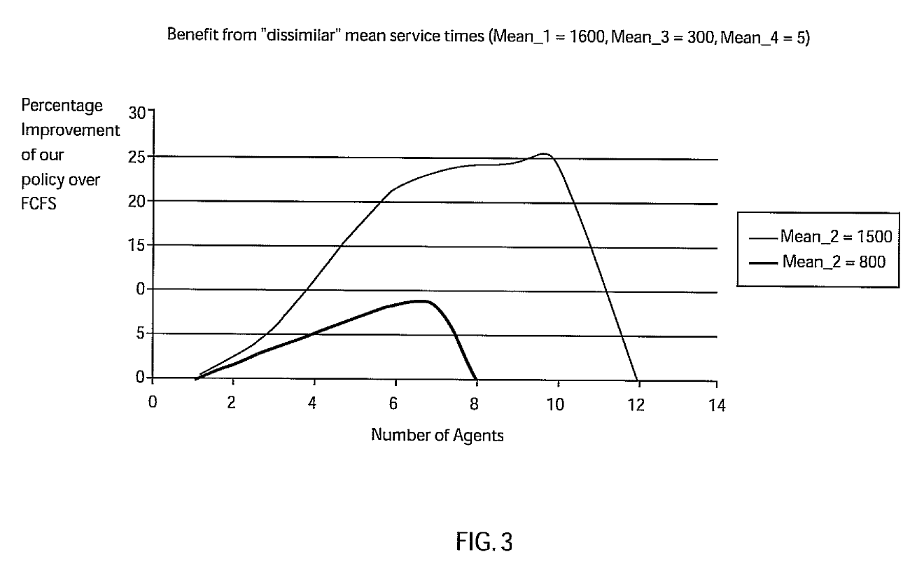

The similarity of the components of a vector, when only component k is varied, is defined with respect to component k+1 since the index based policy would outperform the FCFS only by reducing the higher severity level violations. The benefit from index based policies is higher when the SLA penalty costs (c) are more similar is confirmed as depicted in FIG. 2. A similar result may be obtained for less similar service rates as depicted in FIG. 3, where mean service times (Mean) are varied.

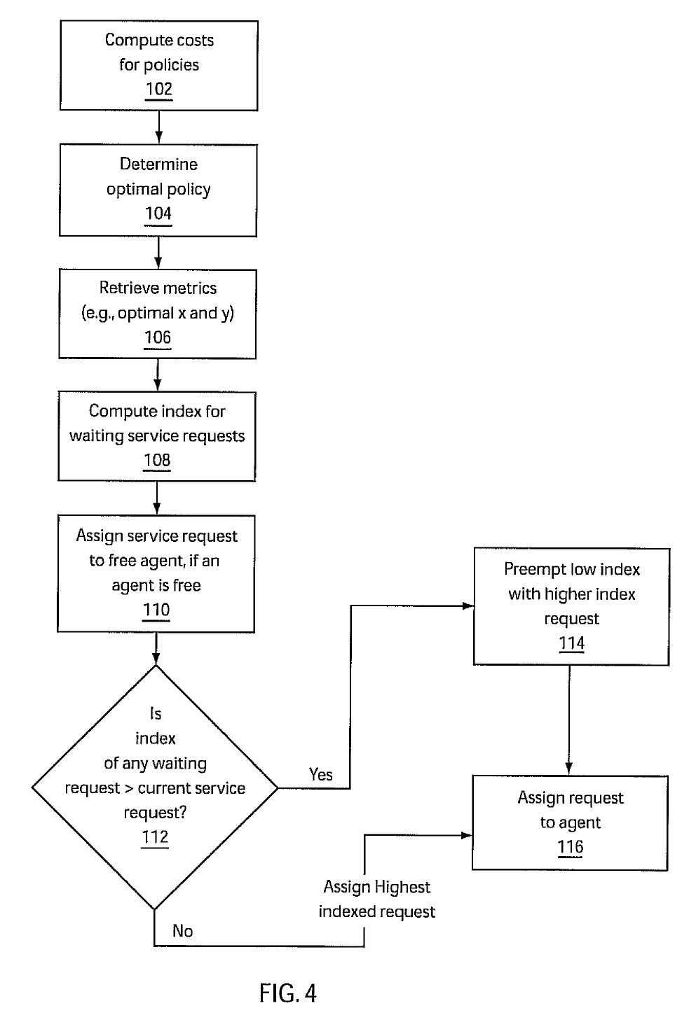

Referring to FIG. 4, a block/flow diagram shows a system/method for making assignment decisions for a service request submitted by a customer. In block 102, a cost of operating each of a plurality of different policies is computed. This may include simulating the cost of each policy for a given x and y, i.e., for a given arrival stream of service requests (based on historical data). The costs are assigned to agents according to an index-based policy with parameters x and y. Consequently, the total cost associated with SLA violations may be computed for a certain time horizon. In block 104, an optimal policy is determined within the class. This may be determined based upon historic data collected. An optimal index based policy may be determined, within the class of index based policies by performing an exhaustive search for different values of x and y. The policy may be selected based upon other desired application specifications or desired criteria. Blocks 102 and 104 may be performed in a batch process. For example, these blocks may be processed once a day, once a week, etc.

Once the policy is selected, optimal metrics are retrieved in block 106. For example, x* and y* are returned based upon an optimal policy. With the x* and y* values, an index (for each severity level) can be computed for all waiting service requests, if there is a service request waiting in block 108. An index may be computed as Inₖ(t)=(cₖ)^{x}(μₖ)^{y}Iₖ(t) by plugging the optimal values x* and y* for x and y, where cₖ is the penalty cost incurred if a service request is not resolved within its due date (Dₖ), μₖ is the service rate of severity k, Iₖ(t)=Nₖ(t)/λₖDₖ, where Nₖ(t) is the number of severity k requests in the system at time t, and Dₖ is the due date of severity k service requests. The new policy class with two parameters, x and y, called the index-based class of policies provides, for a given x and y, a modification of the GLQ policy with a SLA penalty cost and service rate term considered multiplicatively.

In block 110, a waiting service request is assigned to an agent, if one is free. In block 112, a comparison is made between an index for a current request for service and the index of any waiting service request. For example, if the index of any waiting service request is greater than the index of a current service request, then the low index current service request is preempted in block 114 and assigned to an agent in block 116. If the index of any waiting service request is not greater than the index of a current service request, then the highest index (current service request) is assigned to an agent in block 116.

Alternately, a recommendation may be generated/output for when to assign a service request and when to preempt a service request. Blocks 106-116 may be performed on an operational level (e.g., after small time increments).

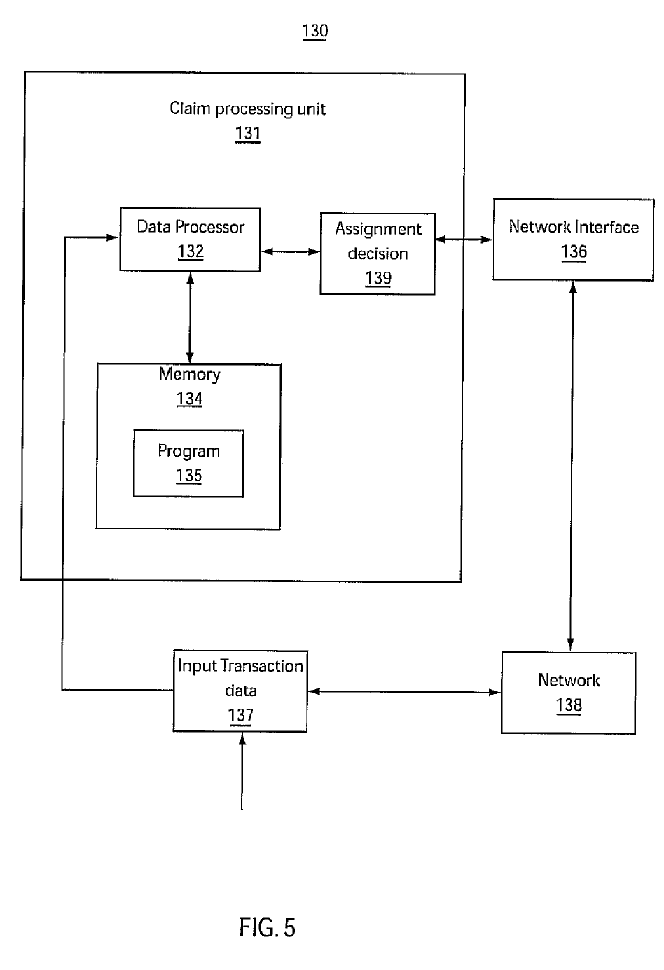

Referring to FIG. 5, a block/flow diagram shows computing system 130 that is one suitable environment for implementing the present principles. The system 130 includes at least one data processor 132 that is coupled with at least one memory 134. The memory 134 stores a program 135 including program instructions that, when executed by the data processor 132, result in the implementation of an assignment system for assigning agents to requests in accordance with the present principles. The data processor 132, memory 134 and program 135 may be considered collectively to form a claim processing unit 131. The data processor 132 is coupled to a network interface 136 providing bi-directional communication with a data communication network 138. Transaction data 137, such as service requests, are input to the data processor 132 and are operated on by the program 135 to produce an assignment decision 139 that is output through the network interface 136. In one embodiment the transaction data 137 can be received from operational database 10 of FIG. 1, and the assignment decision 139 can be output to database 80 to provide historic data for determining an optimal index set as described with reference to FIG. 1.

The system 130 can be embodied in any suitable form, including a main frame computer, a workstation and a portable computer such as a laptop, etc. The data processor 132 can be implemented using any suitable type of processor including, but not limited to, microprocessor(s) and embedded controllers. The memory 134 can be implemented using any suitable memory technology, including one or more of fixed or removable semiconductor memory, fixed or removable magnetic or optical disk memory and fixed or removable magnetic or optical tape memory. The network 138 and network interface 136 can be implemented with any suitable type of wired or wireless network technology, and may include a local area network (LAN) or a wide area network (WAN), including the internet. Communication through the network can be accomplished at least in part using electrical signals, radio frequency signals and/or optical signals.

Based on the foregoing, it should be appreciated that a system, method and computer program product are provided that implement a heuristic method for assigning service requests to agents that is particularly useful in the case of threshold based penalties. The heuristic method belongs to a class of index-based policies that generalize the FCES, SPT, WSPT and GLQ policy. The use of the exemplary embodiments provides a framework for routing service requests to agents. The model provides an ‘easy-to-understand’ intuitive approach to the problem of assigning service requests to agents. The class of policies is robust, in the sense that it generalizes well-known policies such as the FCFS, SPT, WSPT and GLQ.

It should be noted that while the foregoing description has been presented in the context of routing service requests to agents, there are other possible modeling opportunities for managing the process. For example, in customer care management solutions and services, especially in call center operations, each service request can be considered as an incoming customer service call, with an expectation of service level, whether it is terms of FCR (first call resolution), number of service requests needed before a customer problem is resolved, quality of response to address the customer issue, and quality of the call conduct. The present principles can be employed in such scenarios. Severity level could take the form of priority levels of customers, thereby implicitly assigning priority to the incoming customer calls. The penalty can range from low scores to losing the customer business. The penalty can therefore be modeled appropriately in cost terms.

Having described preferred embodiments of systems and methods (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for assigning service requests, comprising:
determining a best policy, within a class of index-based policies, based upon historic data for handling previous requests;
if a service request is waiting to be handled:
determining an index for service requests based upon the best policy;
assigning the service request to an agent based upon the index; and
preempting a service request if a waiting service request has a higher priority index.

2. The method as recited in claim 1, wherein determining a best policy includes providing a general form of an index-based policy such that parameter values of the general form reduce the general form to other policies.

3. The method as recited in claim 2, wherein the other policies include one or more of First-Come-First-Serve (FCFS), Shortest Processing Time (SPT), Weighted Shortest Processing Time (WSPT), and Generalized Longest Queue (GLQ).

4. The method as recited in claim 1, wherein determining a best policy includes performing an exhaustive search of a data base where the cost of each policy within a class of index based policies, determined through simulation, is stored and selecting a minimum cost policy.

5. The method as recited in claim 1, wherein determining a best policy includes providing parameters associated with the best policy.

6. The method as recited in claim 5, wherein determining an index for service requests based upon the best policy includes computing the index using the parameters associated with the best policy.

7. The method as recited in claim 6, wherein the parameters include x and y and the index is computed by:
Inₖ(t)=(cₖ)^{x}(μₖ)^{y}Iₖ(t), where cₖ is the penalty cost incurred if a service request is not resolved within its due date Dₖ of severity k service requests, μₖ is the service rate of severity k,
$${I}_{k} ( t ) = \frac{{N}_{k} ( t )}{{λ}_{k} {D}_{k}} ,$$
where Nₖ(t) is the number of severity k requests in the system at time t.

8. The method as recited in claim 7, wherein determining an index for service requests based upon the best policy includes computing the index using the parameters associated with the best policy.

9. A computer readable medium comprising a computer readable program for assigning service requests, wherein the computer readable program when executed on a computer causes the computer to perform the steps of:
determining a best policy, within a class of index-based policies, based upon historic data for handling previous requests;
if a service request is waiting to be handled:
determining an index for service requests based upon the best policy;
assigning the service request to an agent based upon the index; and
preempting a service request if a waiting service request has a higher priority index.

10. The computer readable medium as recited in claim 9, wherein determining a best policy includes providing a general form of an index-based policy such that parameter values of the general form reduce the general form to other policies.

11. The computer readable medium as recited in claim 10, wherein the other policies include one or more of First-Come-First-Serve (FCFS), Shortest Processing Time (SPT), Weighted Shortest Processing Time (WSPT), and Generalized Longest Queue (GLQ).

12. The computer readable medium as recited in claim 9, wherein determining a best policy includes performing an exhaustive search of a data base where the cost of each policy within the class of index based policies, determined through simulation, is stored and selecting the minimum cost policy.

13. The computer readable medium as recited in claim 9, wherein determining a best policy includes providing parameters associated with the best policy.

14. The computer readable medium as recited in claim 13, wherein determining an index for service requests based upon the best policy includes computing the index using the parameters associated with the best policy.

15. The computer readable medium as recited in claim 14, wherein the parameters include x and y and the index is computed by:
Inₖ(t)=(cₖ)^{x}(μₖ)^{y}Iₖ(t), where cₖ is the penalty cost incurred if a service request is not resolved within its due date Dₖ of severity k service requests, μₖ is the service rate of severity k,
$${I}_{k} ( t ) = \frac{{N}_{k} ( t )}{{λ}_{k} {D}_{k}} ,$$
where Nₖ(t) is the number of severity k requests in the system at time t.

16. The computer readable medium as recited in claim 15, wherein determining an index for service requests based upon the best policy includes computing the index using the parameters associated with the best policy.

17. A method for assigning service requests, comprising:
simulating a cost of an index based policy for a given set of metrics, x and y;
determining an optimal index based policy, within a class of index based policies, by performing an exhaustive search of historic data;
if there is a waiting service request:
computing an index for each of a plurality of severity levels;
assigning a waiting service request to an agent, if an agent is free; and
preempting a lowest index service request that is being processed by a highest index service request that is waiting, if no agent is free.

18. The method as recited in claim 17, wherein determining an optimal index based policy includes providing a general form of an index-based policy such that parameter values of the general form reduce the general form to other policies.

19. The method as recited in claim 18, wherein the other policies include one or more of First-Come-First-Serve (FCFS), Shortest Processing Time (SPT), Weighted Shortest Processing Time (WSPT), and Generalized Longest Queue (GLQ).

20. The method as recited in claim 18, wherein the x and y parameters are obtained from the best index-based policy and the index is computed by:
Inₖ(t)=(cₖ)^{x}(μₖ)^{y}Iₖ(t), where cₖ is the penalty cost incurred if a service request is not resolved within its due date Dₖ of severity k service requests, μₖ is the service rate of severity k,
$${I}_{k} ( t ) = \frac{{N}_{k} ( t )}{{λ}_{k} {D}_{k}} ,$$
where Nₖ(t) is the number of severity k requests in the system at time t.

21. A system for deciding assignments for service requests, comprising:
an input for receiving a service request submitted by a customer;
a dispatching unit coupled to the input and adapted to assign a service request to an agent, the dispatching unit being adapted to apply a best policy, within a class of index-based policies, based upon historic data for handling previous requests, to determine an index for each service request, the index being based upon parameters provided by a determination of the best policy, the dispatching unit assigning service requests based on the index such that service requests are preempted if a waiting service has a higher index than other service requests; and
an output coupled to the dispatching unit for outputting a recommendation of when and to which agent to route a service request.

22. The system as recited in claim 21, wherein the best policy includes a general form of an index-based policy such that parameter values of the general form reduce the general form to other policies.

23. The system as recited in claim 22, wherein the other policies include one or more of First-Come-First-Serve (FCFS), Shortest Processing Time (SPT), Weighted Shortest Processing Time (WSPT), and Generalized Longest Queue (GLQ).

24. The system as recited in claim 21, wherein the best policy provides parameters associated with the best policy and the index is computed using the parameters associated with the best policy.

25. The system as recited in claim 24, wherein the parameters include x and y and the index is computed by:
Inₖ(t)=(cₖ)^{x}(μₖ)^{y}Iₖ(t), where cₖ is the penalty cost incurred if a service request is not resolved within its due date Dₖ of severity k service requests, μₖ is the service rate of severity k,
$${I}_{k} ( t ) = \frac{{N}_{k} ( t )}{{λ}_{k} {D}_{k}} ,$$
where Nₖ(t) is the number of severity k requests in the system at time t.
